(19) United States
(12) Patent Application Publication
(10) Pub. No.: US 2017/0306678 A1
(43) Pub. Date: Oct. 26, 2017

(54) POPUP DEVICE

(71) Applicant: AISIN SEIKI KABUSHIKI KAISHA, Kariya-shi (JP)

(72) Inventors: Shintaro SUZUKI, Kariya-shi (JP); Tomokazu SEKI, Kariya-shi (JP)

(73) Assignee: AISIN SEIKI KABUSHIKI KAISHA, Kariya-shi (JP)

(21) Appl. No.: 15/526,523

(22) PCT Filed: Sep. 28, 2015
(86) PCT No.: PCT/JP2015/004900

§ 371 Date: May 12, 2017

(30) Foreign Application Priority Data
Nov. 27, 2014 (JP) 2014-240535

(51) Int. Cl. E05F 1/00; B60J 5/04; E05F 5/00

(52) U.S. Cl. CPC E05F 1/00; E05F 5/00; B60J 5/0493; E05Y 2201/686; E05Y 2900/531; E05Y 2201/638

(57) ABSTRACT

The pop-up apparatus includes a door check, a check link, the check link being configured to perform relative movement with respect to the door check between the one end and another end of the check link while being applied with a pushing force by the door check, a popup arm arranged on a side closer to the another end of the check link, the popup arm being configured to turn about a turning axis, the popup arm being configured to apply a force with a side of one end of the popup arm so as to perform the relative movement of the check link in a direction in which the vehicle door is opened, a cam portion having an outer peripheral surface and being configured to turn about a cam axis, and a crank lever configured to move along the outer peripheral surface of the cam portion.

### TECHNICAL FIELD

The present invention relates to a popup device configured to open a vehicle door at a slight angle when the vehicle door of a vehicle such as a passenger automobile is opened.

### BACKGROUND ART

When a person gets on a vehicle, a person who is going to open a vehicle door cannot use hands in some cases. Further, when there is no sufficient space between the vehicle and an object adjacent to the vehicle under this situation, it is necessary to prevent the vehicle door from being brought into contact with the object. In such a case, in order to prevent the vehicle door from being opened at an unintended opening degree, the vehicle door is supported by hand toward an inner side of the vehicle, and is gently opened so as not to be brought into contact with the object adjacent to the vehicle. Therefore, it is conceivable to provide a device capable of opening the vehicle door at a slight angle (referred to as “popup” in Description) as an initial operation for opening the vehicle door so that an edge of the vehicle door can be held when the vehicle door is opened.

FIG. 10 is a view for illustrating a state in which a vehicle door 2 is opened, as viewed from a rear side of the vehicle. Further, FIG. 11A and FIG. 11B are views for illustrating a state in which a vehicle door for a front seat on a right side of the vehicle relative to a traveling direction is opened, as viewed from above the vehicle. In general, the vehicle door 2 is supported on a body 3 so as to be turnable about a rotation axis at a hinge portion 2a arranged on a front side of the vehicle door 2. As illustrated in FIG. 11A, when an operator of the vehicle door 2 opens the vehicle door 2, the vehicle door 2 is moved so that the vehicle door is shifted by a popup amount of a slight distance (Lp), thereby enabling the popup of opening the vehicle door 2 at a slight angle. After that, as illustrated in FIG. 11B, the operator of the vehicle door can open the vehicle door normally.

A popup device can also be achieved, for example, through electric control of rotating the hinge portions 2a provided to the vehicle door 2 by a motor to regulate an opening degree, as in a vehicle door opening/closing device disclosed in Patent Literature 1 or an automobile door control device disclosed in Patent Literature 2. Through the control with software as described above, however, a configuration of a control apparatus becomes more complex for control of the motor, and a weight is increased because of mounting of the control apparatus.

In view of the circumstances described above, for example, an automobile door checker disclosed in Patent Literature 3 or an opening-degree regulation device for a vehicle door disclosed in Patent Literature 4 can be used for a part thereof. In none of Patent Literature 3 and Patent Literature 4, a popup device for a vehicle door is disclosed. For the automobile door checker of Patent Literature 3, a case arranged so as to slide relative to the door checker having one end pivotably supported on a body is mounted to a vehicle door. The door checker corresponds to a plate 21 of Patent Literature 4. A check plate 6 of the door checker of Patent Literature 3 corresponds to a check link 57 illustrated in FIG. 12 of this application. Here, the popup device can be achieved through arrangement of a mechanism configured to push an end of an automobile door checker, which is arranged on a side opposite to the side pivotably supported on the body B, as illustrated in FIG. 12 of this application. Similarly to the door checker disclosed in Patent Literature 3, in a representative example of the popup device, one end 57a of the check link 57 having an elongated shape is supported on a body B of a vehicle so as to be rotatable. The check link 57 pivotably supported on the body B is inserted into a door check case 59 rotationally supported on the vehicle door D and has an upper surface and a lower surface pressed by pressing members 58 arranged inside the door check case 59. The door check case 59 is mounted on the vehicle door D. The door check link 57 and the door check case 59 are arranged so as to be movable relative to each other. Further, in Patent Literature 4, the plate 21 is sandwiched between stoppers 22 to regulate the opening degree of the vehicle door.

In the popup device, for example, it is conceivable to arrange a rockable popup lever 60 as a force applying member, which is not disclosed in Patent Literature 3 and Patent Literature 4, on a side closer to an end portion 57b of the check link 57, being arranged on an opposite side, in a direction in which the check link 57 extends. The popup lever 60 applies a force to the end portion 57b of the check link 57. In FIG. 12, the vehicle door D is closed when the vehicle door D is positioned on a side close to the body B, whereas the vehicle door D is opened when the vehicle door D is moved away from the body B. Here, the popup of the vehicle door D is achieved by turning the another end portion 57b of the check link 57 so as to apply the force (F) by the popup lever 60. For example, when the force F is applied to the another end portion 57b of the check link 57 by the turnable popup lever 60, the door check case 59 is moved by an inertia force P along the check link 57 relative to the check link 57. The vehicle door D fixed to the door check case 59 is moved toward the another end portion 57b side of the check link 57 by a slight popup distance. As a result, the vehicle door D is slightly opened.

### CITATION LIST

### Patent Literature

PTL 1: Japanese Patent Application Laid-Open No. 2004-338535

PTL 2: Japanese Patent Application Laid-Open No. 2008-2085

PTL 3: Japanese Patent Application Laid-Open No. 2003-118369

PTL 4: Japanese Patent Application Laid-Open No. 2008-121196

### SUMMARY OF INVENTION

### Technical Problem

Even when the force F is applied to the another end portion of the check link by the popup lever, however, there arises a need of achieving a predetermined sequence within a predetermined time so as to achieve stable popup. The popup sequences are desired to be configured so that the force can be applied to the another end portion of the check link by the popup lever with a simple configuration without the electric control.

### Solution to Problem

According to one embodiment of the present invention, it is provided, a pop-up apparatus for a vehicle door, including a door check configured to be fixed to a vehicle door, a check link having one end to be supported on a vehicle body so as to be turnable, the check link being configured to perform relative movement with respect to the door check between the one end and another end of the check link while being applied with a pushing force by the door check, a popup lever arranged on a side closer to the another end of the check link, a popup lever being configured to turn about a turning axis, the popup lever being configured to apply a force with a side of one end of the popup lever so as to perform the relative movement of the check link in a direction in which the vehicle door is opened, a cam portion having an outer peripheral surface and being configured to turn about a cam axis; and a crank lever configured to move along the outer peripheral surface of the cam portion, wherein, when the cam portion is rotated in one direction around the cam axis, the crank lever is moved along the outer peripheral surface of the cam portion so that the one end of the popup lever applies the force to the check link to cause the relative movement to pop up the vehicle door.

According to another embodiment of the present invention, it is further provided, a pop-up apparatus for a vehicle door, which is to be mounted to a vehicle body, including a popup lever, which is arranged on a side closer to another end of a check link having one end supported on a vehicle body so as to be turnable, a popup lever being configured to turn about a turning axis, the popup lever being configured to apply a force with a side of one end of the popup lever so as to perform relative movement of the check link in a direction in which the vehicle door is opened, and a cam portion having an outer peripheral surface and being configured to turn about a cam axis, wherein, when the cam portion is rotated in one direction of the outer peripheral surface of the cam portion, a crank lever is moved along the outer peripheral surface of the cam portion so that the one end of the popup lever applies a force to the check link to cause the relative movement so as to pop up the vehicle door.

### Advantageous Effects of Invention

The popup lever is operated by the cam portion with a predetermined sequence so that the force can be applied to the another end portion of the check link without electrically configuring a control system.

### BRIEF DESCRIPTION OF DRAWINGS

FIG. 1 is a view for illustrating a popup device according to an embodiment of the present invention, and for illustrating a state immediately before popup, that is, a state in which a vehicle door is closed.

FIG. 2 is a view for illustrating a popup sequence of the present invention.

FIG. 3 is a view for illustrating the popup device according to the embodiment of the present invention, and for illustrating a state in which a latch of the door is released before start of a popup operation.

FIG. 4 is a view for illustrating the popup device according to the embodiment of the present invention, and for illustrating a state before the popup operation.

FIG. 5 is a view for illustrating the popup device according to the embodiment of the present invention, and for illustrating a state during the popup operation.

FIG. 6 is another view for illustrating the popup device according to the embodiment of the present invention, and for illustrating the state during the popup operation.

FIG. 7 is a view for illustrating the popup device according to the embodiment of the present invention, and for illustrating a state at the end of the popup operation.

FIG. 8 is a view for illustrating the popup device according to the embodiment of the present invention, and for illustrating a state after the end of the popup operation.

FIG. 9 is a view for illustrating the popup device according to the embodiment of the present invention, and for illustrating a state after the end of the popup operation.

FIG. 10 is a view for illustrating a vehicle under a state in which the vehicle door is opened, as viewed from a rear side of the vehicle.

FIG. 11A is a view for illustrating an opening degree of the vehicle door when the vehicle door is popped up.

FIG. 11B is a view for illustrating how the vehicle door is opened after the end of the popup of the vehicle door.

FIG. 12 is a view for illustrating a representative example of the popup device.

### DESCRIPTION OF EMBODIMENTS

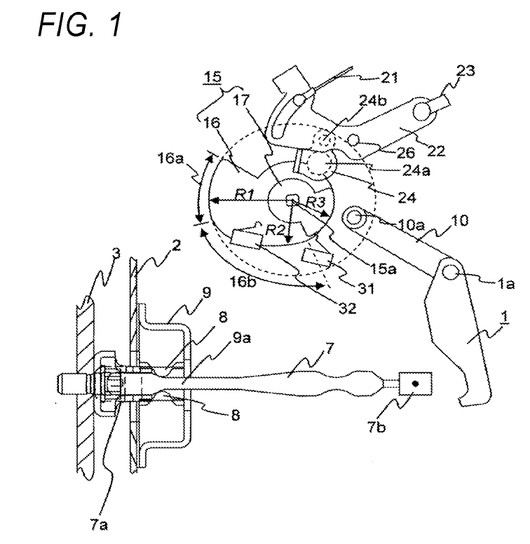

Hereinafter, a popup device for a vehicle door 2 according to the present invention is described with reference to FIG. 1. FIG. 1 is a view for illustrating a popup device according to a first embodiment of the present invention. The popup device includes a popup lever 1, a cam portion 15, a check link 7, and a door check 9.

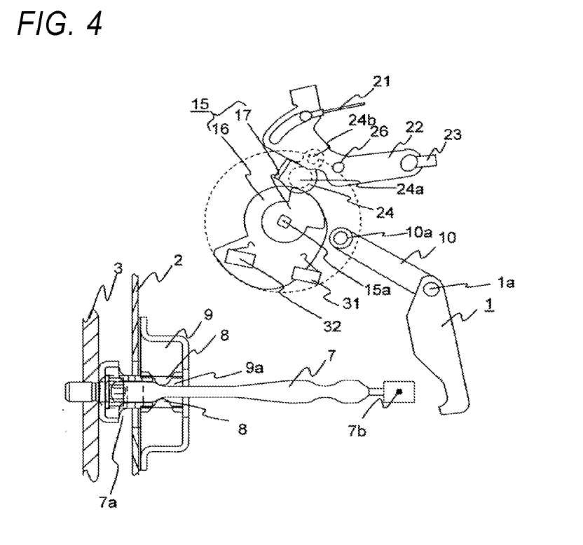

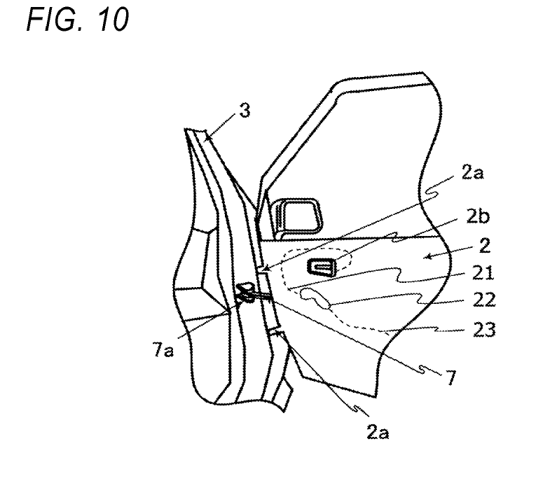

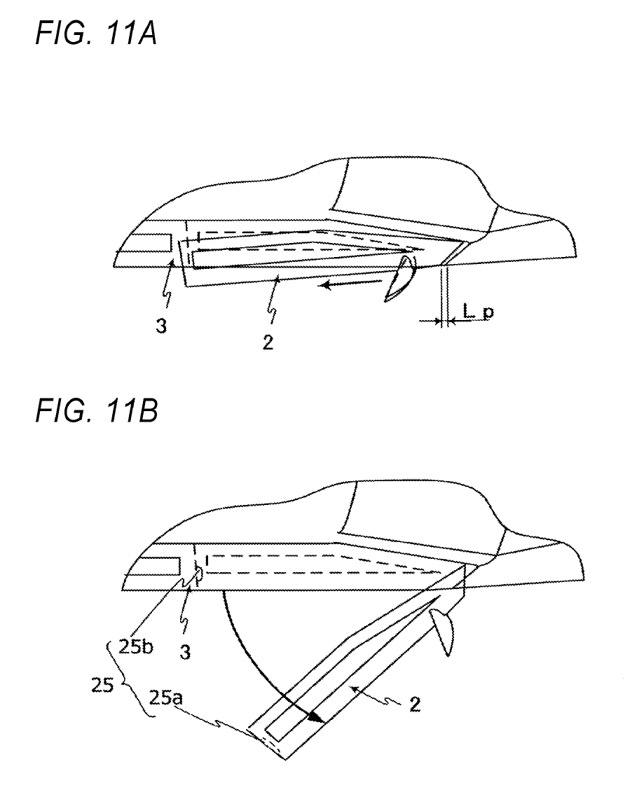

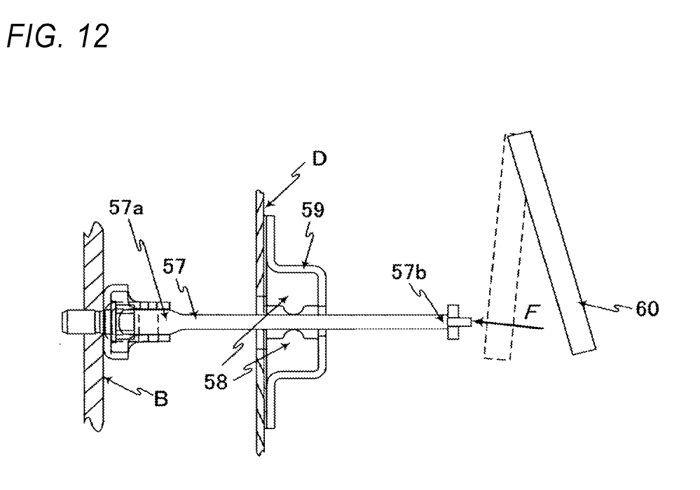

As illustrated in FIG. 10, the vehicle door 2 is supported on a body 3 so as to be turnable about a turning axis 4 at a hinge portion 2a arranged on a front side of the vehicle door 2, as in the related art. In the vicinity of the hinge portion 2a of the vehicle door 2, the check link 7 is mounted so as to regulate an opening degree of the vehicle door 2. The check link 7 has an elongated shape. One end 7a of the check link 7 is supported on the body 3 so as to be rotatable. Another end 7b of the check link 7 on a side opposite to the one end 7a supported on the body 3 is inserted into the vehicle door 2 through a hole formed in a wall surface of the vehicle door 2 on a side on which the hinge portion 2a of the vehicle door 2 is arranged. On a side of the another end 7b of the check link 7, toward which the check link 7 extends, the popup lever 1 is mounted. The vehicle door 2 has a latch mechanism 25 including a latch claw 25a provided to an end surface of the vehicle door 2 on a side opposite to the hinge portion 2a and a hook 25b provided to a body portion corresponding thereto so that the vehicle door is not opened when closed. The latch mechanism 25 is engaged with the body 3 through engagement of the latch claw 25a with the hook 25b under a state in which the vehicle door 2 is closed. In this state, the vehicle door 2 is not opened. Meanwhile, the engagement between the vehicle door 2 and the body 3 is released by releasing the engagement between the latch claw 25a and the hook 25b. When an outward force is applied to the vehicle door 2 in this state, the vehicle door 2 is separated from the body 3 so that the vehicle door 2 is opened. The latch mechanism 25 is released by a latch release device 2b. One end of a first line member 21 formed of an elongated member, for example, a wire is connected to a lever of the latch release device. Another end of the first line member 21 is connected to one end of a latch release link 22. One end of a second line member 23 similarly formed of an elongated member such as a wire is connected to another end of the latch release link 22. The second line member 23 is connected to the latch claw 25a of the latch mechanism 25. The latch release link 22 is rotatable so as to rock about a turning axis 26. When the lever of the latch release device 2b is pulled, the first line member 21 is pulled. As a result, the latch release link 22 is turned about the turning axis 26. That is, for example, a posture of the latch release link 22 illustrated in FIG. 1 changes to a posture of the latch release link 22 illustrated in FIG. 4. With this, the second line member 23 pulls the latch claw 25a of the latch mechanism 25 to disengage the latch claw 25a from the hook 25b provided to the body portion, thereby releasing the engagement. Meanwhile, for engagement, when the latch claw 25a is inserted into the hook 25b, the latch claw 25a and the hook 25b are automatically engaged with each other. When the latch release device 2b is returned, the first line member 21 and the second line member 23 are pushed back into original states. As a result, the posture of the latch release link 22 is returned to an original posture. This return process does not contribute to the engagement between the latch claw 25a and the hook 25b. A pendulum member 24 is mounted to the latch release link 22 turnably about a rocking axis 24b so that the pendulum member 24 is rockable in a direction in which the latch release link 22 is turned. The pendulum member 24 has a projection 24a projecting therefrom. The turning of the latch release link 22 is described as part of a popup operation series in this embodiment. However, only locking and releasing between the vehicle door 2 and the body 3 can be achieved independently from the popup by a cam portion through the turning of the latch release link 22.

On an inner wall of the vehicle door 2, a door check 9 having a through hole 9a is fixed. The check link 7 is inserted into a through hole 9a of the door check 9 so that the door check 9 is positioned between the one end 7a and the another end 7b of the check link 7. Inside the door check 9, pressing members 8 configured to press surfaces of the check link 7 are arranged. The door check 9 slides while the pressing members 8 are pressing sliding surfaces of the check link 7. Specifically, the door check 9 is movable relative to the check link 7 between the one end 7a and the another end 7b of the check link 7. The popup lever 1 is mounted turnably about a turning axis 1a. One end of the popup lever 1 is arranged so as to be positioned at a location in a direction extending from the another end 7b of the check link 7 in a separated state so that a pushing force can be applied to the another end 7b of the check link 7 and functions as a pushing portion configured to push the another end 7b of the check link 7. A crank lever 10 is mounted to another end side of the popup lever 1. The crank lever 10 includes a driven portion 10a arranged at an end portion on a side opposite to a side where the popup lever 1 is mounted. When the driven portion 10a is pushed, the popup lever 1 is rotated about the turning axis 1a.

A cam portion 15 is mounted so as to be turnable about a cam axis 15a, and has an outer peripheral surface on its outer periphery. The driven portion 10a of the crank lever 10 is movable along the outer peripheral surface. The cam portion 15 can representatively include a first cam member 16 and a second cam member 17. An example in which the first cam member 16 and the second cam member 17 are provided is described in this embodiment. The first cam member 16 has a first outer peripheral portion 16a, an outer peripheral surface, and a second outer peripheral portion 16b. The first outer peripheral portion 16a has a circumferential surface having a radius which corresponds to a first distance R1 from the cam axis 15a. The outer peripheral surface is a circumferential surface having a radius which corresponds to a third distance R3 from the cam axis 15a. The second outer peripheral portion 16b is provided between the first outer peripheral portion 16a and the outer peripheral surface, and has an outer peripheral surface being a curved surface having a radius which corresponds to a second distance R2 that allows smooth connection between the first distance R1 and the third distance R3. The first distance R1 and the third distance R3 are constants, whereas the second distance R2 is a variable increasing at a constant rate from the first distance R1 to the third distance R3. On a trajectory of the first outer peripheral portion 16a and the second outer peripheral portion 16b of the first cam member 16, the driven portion 10a of the crank lever 10 is positioned so as to be contactable therewith. Therefore, the driven portion 10a of the crank lever 10 is movable at least along the first outer peripheral portion 16a and the second outer peripheral portion 16b of the first cam member 16. Specifically, the radius of the second outer peripheral portion 16b is increased at the constant rate, and hence, when the first cam member 16 turns about the cam axis 15a, the driven portion 10a of the crank lever 10 is moved from an original position along with the turning of the first cam member 16. As a result, an angle of the crank lever 10 is changed so that the popup lever 1 turns about the turning axis 1a. The driven portion 10a of the crank lever 10 is not always required to be brought into contact with a portion of the second cam member 17, which have the third distance R3, but setting may be made to achieve the contact therebetween. Even when the contact is achieved, the driven portion 10a of the crank lever 10 maintains the constant third distance R3 from the cam axis 15a for a given time period corresponding to the portion having the third distance R3 in accordance with rotation of the first cam member 16 to maintain a state in which the angle of the crank lever 10 remains unchanged.

The second cam member 17 is a cam having a radius smaller than that of the first cam member 16. The second cam member 17, representatively at least in part thereof, has an outer peripheral surface which matches with the outer peripheral surface being the circumferential surface of the first cam member 16, which has a radius corresponding to the third distance R3 from the cam axis 15a. The second cam member 17 is the cam having an outer peripheral shape with a radius portion smaller than the third distance R3 for the remaining portion. The first cam member 16 and the second cam member 17 are mounted coaxially and integrally to the cam axis 15a in an overlapping manner so that the respective outer peripheral shapes having the radius portions of the third distance R3 match with each other. The first cam member 16 and the second cam member 17 rotate integrally. On trajectory portions of the outer peripheral shapes of the second cam member 17, which have the radius portions of the third distance R3, the projection 24a of the pendulum member 24 mounted to the latch release link 22 is positioned. The position of the projection 24a of the pendulum member 24 mounted to the latch release link 22 is set so as to be positioned at a location at which a distance from the cam axis 15a is smaller than the third distance R3. A portion of the second cam member 17 other than the portion having the third distance R3 has the outer peripheral shape with the radius portion smaller than the third distance R3. Therefore, when the outer peripheral portion of the second cam member 17, which has the third distance R3, comes into contact with the projection 24a, the projection 24a is pushed by the outer peripheral portion having the third distance R3 to rotate the pendulum member 24. As a result, an end portion of the pendulum member 24 pushes up the latch release link 22 to turn the latch release link 22 about the turning axis 26. In this manner, even without pulling the first line member 21, the second line member 23 pulls the latch claw 25a of the latch mechanism 25 to disengage the latch claw 25a from the hook 25b of the body portion, thereby enabling the release of the engagement.

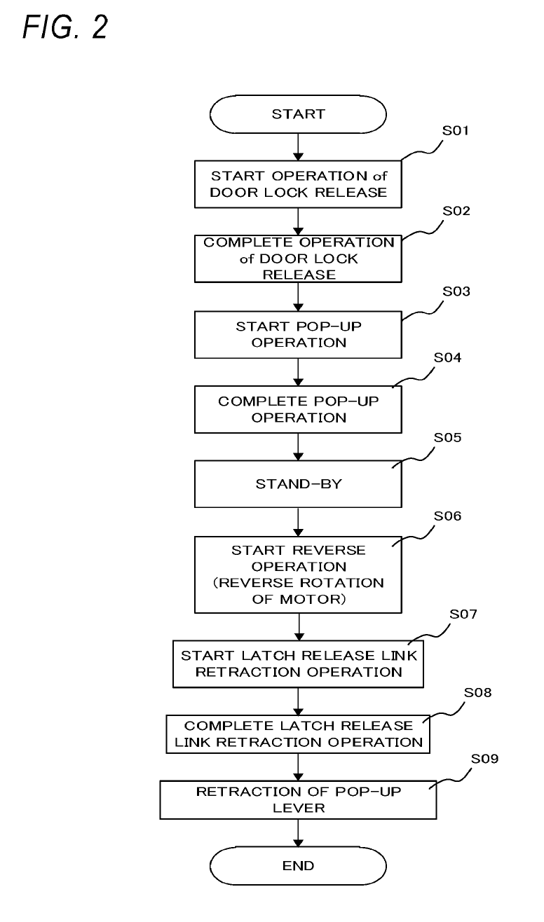

On the trajectory portion of the outer peripheral shapes of the second cam member 17, which have the radius portions of the third distance R3, a contact point of a limit switch 31 and a contact point of a limit switch 32 are respectively arranged. First, when the outer peripheral portion of the second cam member 17, which has the radius portion of the third distance R3, comes into contact with the limit switch 31, a trigger signal that starts a popup sequence series illustrated in FIG. 2 is generated. Meanwhile, the limit switch 32 is arranged so that the contact point is positioned at a position at which a distal end of the portion having the third distance R3 is located after the cam portion 15 terminates the turning of the popup lever 1 and the turning of the latch release link 22. The limit switch 32 is set so that a direction of rotation of the cam portion 15 is reversed when being turned on. Therefore, the limit switch 32 serves to return the cam portion 15 into an initial state after the termination of the turning of the popup lever 1 and the turning of the latch release link 22. It can be set so that the cam portion 15 is stopped when a rear end of the portion having the third distance R3 pushes the limit switch 31 again after the limit switch 32 is turned on to return the cam portion 15 to the initial position.

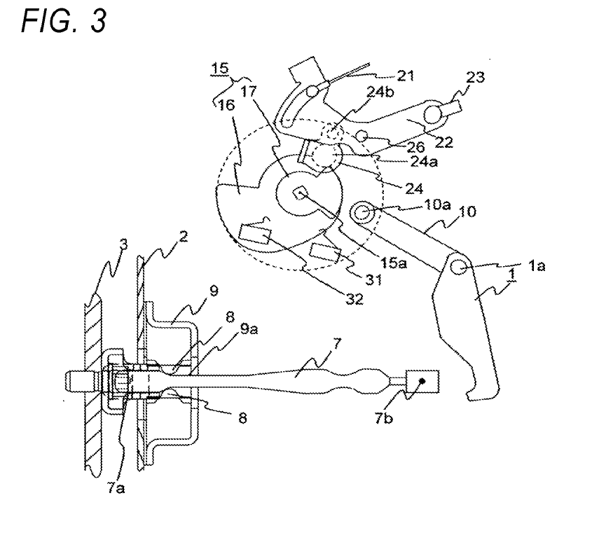

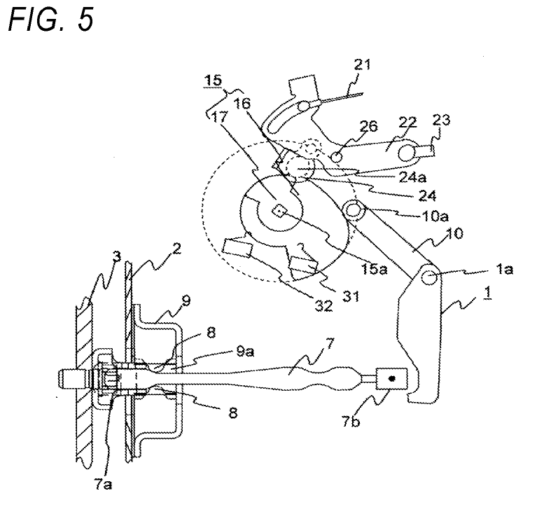

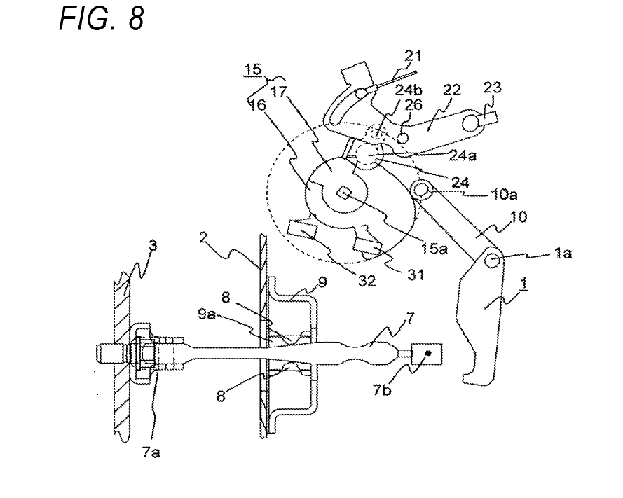

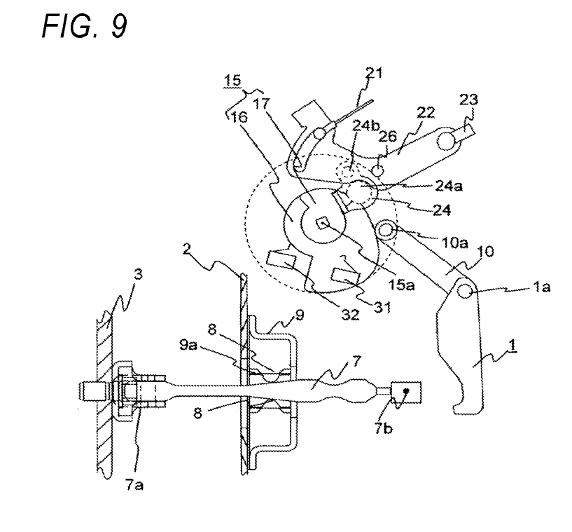

Next, an operation of the popup device of the present invention is described with reference to FIG. 1 to FIG. 9. FIG. 1, FIG. 3 and FIG. 4 are views before the popup, for illustrating a state in which the vehicle door 2 is closed. FIG. 5 to FIG. 7 are views for illustrating a state during the popup operation. FIG. 8 and FIG. 9 are views for illustrating a state in which the cam portion 15 returns to the initial position after the end of the popup operation. As illustrated in FIG. 1, the popup lever 1 is positioned away from the check link 7. The driven portion 10a of the crank lever 10 is positioned at the location corresponding to the portion of the cam portion 15, which has the third distance R3. After an operator of the vehicle door 2 turns on the popup device, the cam portion 15 starts rotating about the cam axis 15a in a direction of first causing the second outer peripheral portion 16b of the first cam member 16 to come into contact with the driven portion 10a of the crank lever 10 and then causing the first outer peripheral portion 16a to come into contact therewith. Once the rotation is started, the cam portion 15 rotates in the same direction without stopping until the limit switch 31 or the limit switch 32 starts operating. Along with the rotation of the cam portion 15 about the cam axis 15a, as illustrated in FIG. 3, the distal end of the portion of the cam portion 15, which corresponds to the third distance R3, comes into abutment against the pendulum member 24 before the second outer peripheral portion 16b of the first cam member 16 comes into abutment against the driven portion 10a of the crank lever 10. Then, as illustrated in FIG. 4, the portion of the cam portion 15, which corresponds to the third distance R3, comes into abutment against the projection 24a (Step S01 of FIG. 2). Thus, the end portion of the pendulum member 24a pushes up the latch release link 22 to turn the latch release link 22 about the turning axis 26. As a result, the latch release link 22 pulls the second line member 23. Then, the second line member 23 pulls the latch claw 25a of the latch mechanism 25 to disengage the latch claw 25a from the hook 25b provided to the body portion, thereby releasing the engagement (Step S02 of FIG. 2).

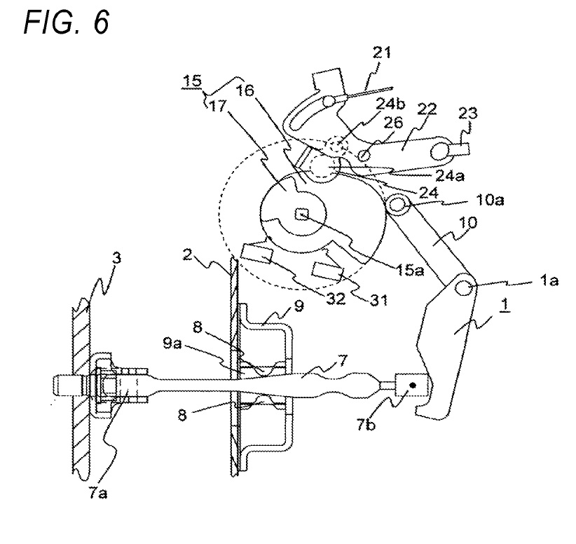

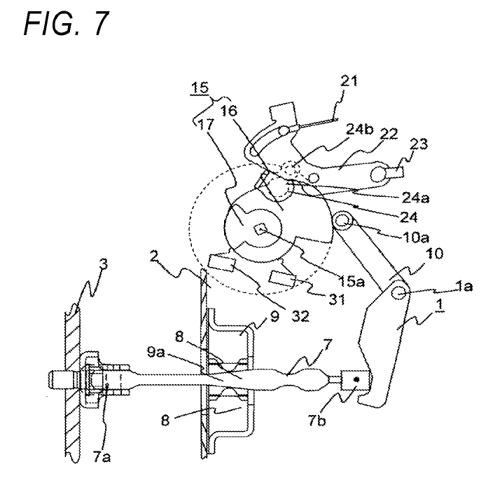

When the lock of the vehicle door 2 is released, as illustrated in FIG. 5, the second outer peripheral portion 16b of the first cam member 16 comes into abutment against the driven portion 10a of the crank lever 10 approximately at the same time or after elapse of a predetermined time period. This point becomes a starting point of the popup operation (Step S03 of FIG. 2). The second outer peripheral portion 16b is a portion having the distance from the cam axis 15 to the outer peripheral surface, which increases at the constant rate. Therefore, along with the rotation of the cam portion 15, the driven portion 10a of the crank lever 10 is moved away from the cam axis 15 to change a posture angle of the crank lever 10. As a result of the change in posture angle, the popup lever 1 is turned about the turning axis 1a. At any position between a position illustrated in FIG. 5 and a position illustrated in FIG. 6 at which the driven portion 10a of the crank lever 10 is located on the second outer peripheral portion 16b, one end 1b side of the popup lever 1 comes into contact with the another end 7b of the check link 7 to push the check link 7 in a longitudinal direction. By an inertia force generated by an impact thereof, the check link 7 and the door check 9 perform relative movement, thereby performing the popup operation of slightly opening the vehicle door 2 to which the door check 9 is mounted. Then, as illustrated in FIG. 6, the distal end of the first outer peripheral portion 16a of the first cam member 16 comes into abutment against the driven portion 10a of the crank lever 10, thereby terminating the popup operation (Step S04 of FIG. 2). While the distal end of the first outer peripheral portion 16a of the first cam member 16 is held in abutment against the driven portion 10a of the crank lever 10, the driven portion 10a of the crank lever 10 keeps the first distance R1 from the cam axis 15. Therefore, during that time, the popup lever 1 cannot be retreated, and waits in this state for a predetermined time period, for example, about 30 seconds (Step S05 of FIG. 2). Then, as illustrated in FIG. 7, when the distal end of the portion of the cam portion 15, which corresponds to the third distance R3, turns on the limit switch 32, the cam portion 15 starts rotating reversely in an opposite direction (Step S06 of FIG. 2). Then, as illustrated in FIG. 8, when the portion of the cam portion 15, which corresponds to the third distance R3, comes into abutment against the projection 24a, the pendulum member 24 turns in a direction in which the latch release link 22 pushes back the second line member 23, thereby starting an operation of retracting the latch release link 22 (Step S07 of FIG. 2). Thereafter, as illustrated in FIG. 9, the pendulum member 24 comes into abutment against the latch release link 22 so that the latch release link 22 completely pushes back the second line member 23, thereby terminating the retraction of the latch release link 22 (Step S08 of FIG. 2). After that, the driven portion 10a of the crank lever 10 is moved from the first outer peripheral portion 16a of the first cam member 16 to the second outer peripheral portion 16b. As a result, the popup lever 1 is moved reversely to the direction of movement during the popup. At a predetermined position, the driven portion 10a of the crank lever 10 is separated from the outer peripheral portion of the first outer peripheral portion 16a so that the popup lever 1 is completely retracted (Step S09 of FIG. 2). When the portion of the first outer peripheral portion 16a, which corresponds to the third distance R3, turns on the limit switch 31, the rotation of the motor which has turned the cam portion 15 is stopped at this time, thereby terminating the popup operation series.

The turning of the latch release link 22 and operations of the limit switches are performed through use of the second cam member 17 in this embodiment, but may be performed through use of the first cam member 16. The turning and the operations can freely be set by operation timing of the latch release link 22, operation timing of the popup lever 1, and timings of the operations of the limit switches. For example, a time of start of Step S03 of FIG. 2 can be set to the same time as Step S02 of FIG. 2 in relation therewith. Alternatively, the start of Step S03 of FIG. 2 can be set to before Step S02 of FIG. 2. Further, although the example in which the first cam member 16 and the second cam member 17 are mounted coaxially to the cam axis has been described, the first cam member 16 and the second cam member 17 can be rotated about different axes. As long as setting is determined so that the entire cam portion 15 performs the above-mentioned operations, the number and arrangement positions of cam members constructing the cam portion 15 can freely be set.

This application claims the benefit of priority from Japanese Patent Application No. 2014-240535, filed on Nov. 27, 2014, the content of which is incorporated herein by reference.

### REFERENCE SIGNS LIST

1 popup lever
1a turning axis
2 vehicle door
3 body
7 check link
8 pressing member
9 door check
10 crank lever
15 cam portion
16 first cam member
17 second cam member
22 latch release link

1. A pop-up apparatus for a vehicle door, comprising:
a door check configured to be fixed to a vehicle door;
a check link having one end to be supported on a vehicle body so as to be turnable, the check link being configured to perform relative movement with respect to the door check between the one end and another end of the check link while being applied with a pushing force by the door check;
a popup lever arranged on a side closer to the another end of the check link, the popup lever being configured to turn about a turning axis, the popup lever being configured to apply a force with a side of one end of the popup lever so as to perform the relative movement of the check link in a direction in which the vehicle door is opened;
a cam portion having an outer peripheral surface and being configured to turn about a cam axis; and
a crank lever configured to move along the outer peripheral surface of the cam portion,
wherein when the cam portion is rotated in one direction around the cam axis, the crank lever is moved along the outer peripheral surface of the cam portion so that the one end of the popup lever applies the force to the check link to cause the relative movement to pop up the vehicle door.

2. A pop-up apparatus for a vehicle door according to claim 1, wherein a predetermined time interval is provided between a time of completion of the relative movement including after the time of completion of the relative movement and a time at which a selector switch, which is configured to switch a direction of rotation of a driving device for the cam portion so that the cam portion rotates in a direction opposite to the one direction, reacts in accordance with a position of the cam portion.

3. A pop-up apparatus for a vehicle door according to claim 1, wherein after completion of the relative movement, a selector switch, which is configured to switch a direction of rotation of a driving device for the cam portion so that the cam portion rotates in a direction opposite to the one direction, reacts in accordance with a position of the cam portion so that the cam portion rotates in the opposite direction to return the popup lever to an original position.

4. A pop-up apparatus for a vehicle door according to claim 1,
wherein the vehicle door comprises:
a latch mechanism configured to perform a lock of the vehicle door to the vehicle body when the vehicle door is closed; and
a latch release device configured to perform a release of the lock,
wherein the pop-up apparatus comprises a latch release link capable of turning, which has one end connected to the latch release device through a first line member and another end connected to the latch mechanism through a second line member,
wherein when the first line member is pulled by the latch release device, the latch release link performs the turning to pull the second line member so as to cause the latch mechanism to perform the release of the lock,
wherein when the cam portion performs the rotation in the one direction around the cam axis so that the one end of the popup lever causes the relative movement of the check link, the cam portion causes turning so that the latch release link pulls the second line member to cause the latch mechanism to perform the release of the lock.

5. A pop-up apparatus for a vehicle door according to claim 4, wherein when the cam portion rotates in the opposite direction, the latch release link causes turning so that the latch release link pushes back the second line member to cause the latch mechanism to perform the lock.

6. A pop-up apparatus for a vehicle door, which is to be mounted to a vehicle body, comprising:
a popup lever, which is arranged on a side closer to another end of a check link having one end supported on a vehicle body so as to be turnable, the popup lever being configured to turn about a turning axis, the popup lever being configured to apply a force with a side of one end of the popup lever so as to perform relative movement of the check link in a direction in which the vehicle door is opened; and
a cam portion having an outer peripheral surface and being configured to turn about a cam axis,
wherein when the cam portion is rotated in one direction of the outer peripheral surface of the cam portion, a crank lever is moved along the outer peripheral surface of the cam portion so that the one end of the popup lever applies a force to the check link to cause the relative movement so as to pop up the vehicle door.
